(19) United States
(12) Patent Application Publication
(10) Pub. No.: US 2011/0064962 A1
(43) Pub. Date: Mar. 17, 2011

(54) ALUMINUM DIE CASTING PRODUCTS AND THEIR REFORMING

(75) Inventors: Kenya OHASHI, Hitachinaka (JP); Takayoshi HIKICHI, Mito (JP); Kazumi FUJII, Hitachi (JP)

(73) Assignee: Hitachi, Ltd.

(21) Appl. No.: 12/859,900

(22) Filed: Aug. 20, 2010

(30) Foreign Application Priority Data
Sep. 15, 2009 (JP) 2009-213816

(51) Int. Cl. B32B 15/02; H05B 6/10

(52) U.S. Cl. 428/546; 432/1; 219/602

(57) ABSTRACT

An aluminum die casting product which is improved in corrosion resistance and mechanical strength in particular in proof stress, and a reforming method of an aluminum die casting product are provided. The aluminum die casting product according to the present invention contains Si and Cu, and the largest particle of an Al—Cu metallic compound that exists at a crystal grain boundary between Si and Al has a diameter smaller than or equal to 10 μm. The reforming method of the present invention is applied to an aluminum die casting product that contains Si and Cu, and the aluminum die casting product is heated at a temperature higher than or equals to 150° C. and lower than 250° C.

### CROSS REFERENCE TO RELATED APPLICATION

The present application claims benefit of the filing dates of Japanese Patent Application No. 2009-213816 filed on Sep. 15, 2009, which is incorporated herein by reference.

### BACKGROUND OF THE INVENTION

1. Field of the Invention

The present invention relates to an aluminum die casting product that contains Si and Cu and is used for a component in an automobile or a two-wheel vehicle such as a carburetor, an engine block, a cylinder head, a cylinder block, a shock absorber, a side cover, a crankcase, and a component used in a VTR frame and camera body, as well as used for a component in an electric power tool, gas apparatus, an escalator and the like, and also relates to a reforming method of an aluminum die casting product.

2. Description of the Related Art

Aluminum die casting products so called ADC10, ADC12, and ADC14 and so forth that contains Si and Cu has a problem in corrosion resistance due to Cu which accelerates a corrosion reaction. For improving the corrosion resistance of an aluminum die casting product that contains Si and Cu, generally anodizing or coating is applied for coating the surface with other material.

In addition, for example, Japanese Patent Application Laid-open JP2005-139552 discloses a method to control a Cu content in an AL alloy less than or equal to 0.2 mass percent, and an Mg content in a range from 0.1 to 0.5 mass percent. The application JP2005-139552 mentions that, it is possible to improve the corrosion resistance and strength (Vickers hardness: HV) by, lowering the Cu content, which controls a separation of Cu into the alloy, and compensating the shortage of strength due to lowering the Cu content by containing Mg in the range stated above.

However, since anodizing and coating have to be performed as an additional process after producing an aluminum die casting product, it is disadvantageous from the point of cost effectiveness, and also there is a possibility of corrosion in a case when an oxide layer or a coating is removed.

In addition, Mg also accelerates a corrosion reaction, although not strongly as Cu does, the technique disclosed in JP2005-139552 which contains somewhat large amount of Mg is not regarded as having enough corrosion resistance.

In light of the problems above, an object of the present invention is to provide an aluminum die casting product that is superior in corrosion resistance, mechanical strength, in particular in proof stress, and to provide a reforming method of an aluminum die casting product.

### SUMMARY OF THE INVENTION

An aluminum die casting product according to the present invention containing Si and Cu, includes particles of an Al—Cu metallic compound that exist at a crystal grain boundary between a Si crystal grain and an Al crystal grain, and the largest particle of the Al—Cu compound has a diameter smaller than or equal to 10 μm.

Thus, making the diameter of the largest particle of Al—Cu metallic compound in the aluminum die casting product be smaller than or equal to 10 μm, Cu will be separated and the structure becomes uneven, then the coupling field of Al and Cu is reduced compared to a case where Cu is dispersed evenly, and it is possible to increase the coupling field of Al and Al. In addition, Al—Cu metallic compound has a diameter small enough not to become a source of corrosion. In view of this, the aluminum die casting product according to the present invention has improved the corrosion resistance compared to conventional aluminum die casting products.

The reforming method of the present invention is applied to an aluminum die casting product that contains Si and Cu, and heats the aluminum die casting product at a temperature higher than or equals to 150° C. and lower than 250° C. It is preferable to perform the heat treatment by heating the aluminum die casting product by one of applying an alternating electric field, applying high-frequency electromagnetic waves, and a heater.

In this way, heating the aluminum die casting product in a specific temperature range, it is possible to separate Cu and make the largest particle of an Al—Cu metallic compound in the aluminum die casting product have a diameter smaller than or equal to 10 μm. Consequently, such reforming can improve the corrosion resistance of the aluminum die casting product.

The aluminum die casting product according to the present invention has excellent corrosion resistance since the diameter of the largest particle of Al—Cu metallic compound that exists at a crystal grain boundary between a Si crystal grain and an Al crystal grain is made smaller than or equal to 10 μm. The reforming method of an aluminum die casting product according to the present invention is capable of making the diameter of the largest particle of an Al—Cu metallic compound that exists at a crystal grain boundary between a Si crystal grain and an Al crystal grain be smaller than or equal to 10 μm, and consequently it is possible to improve the corrosion resistance of the aluminum die casting product.

### BRIEF DESCRIPTION OF THE DRAWINGS

FIG. 1 shows a perspective view of aluminum die casting product reforming apparatus in an embodiment of the reforming method of an aluminum die casting product according to the present invention;

FIG. 2 is a graph showing a result of an anode polarization measurement in a practical example 1, a comparative example 1 and a comparative example 2;

FIG. 3A is a photograph of a comparative example 3 taken with a Transmission Electron Microscope (TEM);

FIG. 3B is a photograph of a practical example 4 taken with a TEM;

FIG. 3C is a photograph of a practical example 5 taken with a TEM;

FIG. 3D is a photograph of a comparative example 4 taken with a TEM;

FIG. 4 is a histogram showing a relation between superficial area of a particle [μm²] and separation count [count/mm²] of an Al—Cu metallic compound in a practical example 6.

FIG. 5A is a photograph of a comparative example 5 taken with a TEM;

FIG. 5B is a photograph of a practical example 6 taken with a TEM;

FIG. 5C is a photograph of a practical example 7 taken with a TEM;

FIG. 5D is a photograph of a comparative example 6 taken with a TEM;

FIG. 6A is a photograph of a comparative example 7 taken with a TEM;

FIG. 6B is a photograph of a practical example 8 taken with a TEM;

FIG. 6C is a photograph of a practical example 9 taken with a TEM;

FIG. 6D is a photograph of a comparative example 8 taken with a TEM;

FIG. 6E is a photograph of a comparative example 9 taken with a TEM;

FIG. 7 is a graph showing a result of an anode polarization measurement in a practical example 10, a comparative example 1 and a comparative example 10; and

FIG. 8 is a graph showing a mechanical property (tensile strength (stress [MPa])), 0.2% proof stress [MPa], breaking strain [%]) in a practical example 11, a comparative example 11 and a comparative example 12.

### DETAILED DESCRIPTION OF THE PREFERRED EMBODIMENTS

An aluminum die casting product and a reforming method of the aluminum die casting product according to the present invention will be explained in detail below.

First, an aluminum die casting product will be discussed.

An aluminum die casting product according to the present invention contains Si and Cu, and the largest particle of an Al—Cu metallic compound that exists at a crystal grain boundary between a Si crystal grain and an Al crystal grain has a diameter smaller than or equal to 10 μm.

Here, an aluminum die casting product containing Si and Cu means a product manufactured by a die-casting method using so called aluminum die casting alloy such as ADC10, ADC12, and ADC14. Such aluminum die casting products include, for example, a component used in an automobile or a two-wheel vehicle such as a carburetor, an engine block, a cylinder head, a cylinder block, a shock absorber, a side cover, a crankcase, and a component used in a VTR frame and camera body, as well as used for a component in an electric power tool, gas apparatus, an escalator and the like.

As stated above, by making the diameter of the largest particle of an Al—Cu metallic compound that exists at a crystal grain boundary between a Si crystal grain and an Al crystal grain be smaller than or equal to 10 μm, Cu would be separated and the structure becomes uneven. Consequently, the coupling field of Al and Cu is reduced compared to a case where Cu is dispersed evenly, and it is possible to increase the coupling field of Al and Al. In addition, an Al—Cu metallic compound has a diameter small enough not to become a source of corrosion. In view of this, it is possible to improve the corrosion resistance in aluminum die casting products.

In contrast, if the diameter of the largest particle of the Al—Cu metallic compound that exists at a crystal grain boundary between a Si crystal grain and an AI crystal grain exceeds 10 μm, the Al—Cu metallic compound containing coarse Al particles may become a source of corrosion and the corrosion resistance cannot be improved. The diameter of the largest particle of the Al—Cu metallic compound should preferably be made smaller than or equal to 5 μm, more preferably be made smaller than or equal to 3 μm, further preferably be made smaller than or equal to 1 μm, and most preferably be made smaller than or equal to 0.5 μm. In addition, the diameter of the largest particle of the Al—Cu metallic compound should be made preferably larger than or equal to 0.03 μm.

In an aluminum die casting product according to the present invention, it is preferable that the Al—Cu metallic compound particle should have a mode value of grain volume smaller than or equal to 30 μm³. In this case, the mode value of grain volume is small enough and it may not become a source of corrosion. Therefore the corrosion resistance of the aluminum die casting product is further improved.

On the other hand, if the Al—Cu metallic compound particle has a mode value of grain volume larger than 30 μm³, the grain volume is too large and it may become a source of corrosion. Consequently the corrosion resistance of the aluminum die casting product cannot be improved. In addition, it is more preferable to make the Al—Cu metallic compound particle have a mode value of grain volume smaller than or equal to 10 μm³, and is further preferable to make it smaller than or equal to 1 μm³.

It is preferable that an average Cu content of the entire product should be in a range from 1 to 20 mass percent, and a Cu content of a divided volume of 1 mm³ of the aluminum die casting product should be in a range of ±25 percent of the average Cu content (±25 percent of 1 to 20 mass percent, i.e. 0.75 to 25 mass percent). In the aluminum die casting product according to the present invention, Cu is separated and the structure becomes uneven (i.e. Cu is segregated), and the Cu content in the structure is unevenly distributed. Therefore, the relation between the Cu content of the entire product and the Cu content per unit volume after segregation was specified as above.

It is preferable that the average Cu content of the entire product should be in a range from 1 to 20 mass percent so as to obtain the necessary strength as a product for an aluminum die casting product which is reformed by a reforming method according to the present invention. In contrast, it is not preferable if the average Cu content of the entire product is less than 1 mass percent, since it lowers the strength of the aluminum die casting product. In addition, it is not preferable if the average Cu content of the entire product is more than 20 mass percent, since it lowers the strength of the aluminum die casting product due to excessive content of the Cu.

It is preferable that the Cu content in a divided volume of 1 mm³ should be in a range of ±25 percent of the average Cu content of the entire product (±25 percent of 1 to 20 mass percent, i.e. 0.75 to 25 mass percent), then Cu will be dispersed and separated as an Al—Cu metallic compound, which leads to good corrosion resistance. In contrast, it is not preferable if the Cu content in a divided volume of 1 mm³ is less than −25 percent of the average Cu content of the entire product (less than −25 percent of 1 to 20 mass percent, i.e. less than 0.75 mass percent), because a lot of bonds between Al still exist while Cu may be dispersed and separated as an Al—Cu metallic compound. In addition, it is not preferable if the Cu content in a divided volume of 1 μmm³ is more than +25 percent of the average Cu content of the entire product (more than +25 percent of 1 to 20 mass percent, i.e. more than 25 mass percent), because in some areas Cu may be dispersed and separated as an Al—Cu metallic compound while in some areas Cu may not be enough.

While the Cu content in a divided volume of 1 mm³ can be measured with an analysis equipment, but also it may be obtained by calculating the content of the Al—Cu metallic compound in unit area (mm²) i.e. the Cu content in unit area (mm²) derived from the superficial area of a particle and the separation count, and assuming that Cu is also distributed in the thickness direction.

The aluminum die casting product explained above can be obtained by, first producing an aluminum die casting product using aluminum die casting alloy based on a die casting method, and then performing an after-mentioned reforming method to the produced aluminum die casting product.

Next, the reforming method of an aluminum die casting product according to the present invention will be explained.

The reforming method of an aluminum die casting product according to the present invention is applied to an aluminum die casting product containing Si and Cu, and heats the aluminum die casting product at a temperature higher than or equal to 150° C. and lower than 250° C. When the aluminum die casting product produced based on a die casting method is heated in a specific temperature range described above, Cu in the structure will be separated and the diameter of the largest particle of an Al—Cu metallic compound that exists at a crystal grain boundary between Si and Al can be made smaller than or equal to 10 μm.

If the heating temperature of the aluminum die casting product is lower than 150° C., Cu may not be separated and the uneven structure with Cu separated cannot be obtained. On the other hand, if the heating temperature of the aluminum die casting product is higher than or equal to 250° C., Cu may be dispersed and the structure will become even. So, it is preferable that the upper limit of the heating temperature be around 230° C.

It is preferable to perform the heat treatment by heating the aluminum die casting product by one of applying an alternating electric field, applying high-frequency electromagnetic waves, and a heater. An electrically-heated wire may be used as well.

By performing one of the process above to the aluminum die casting product, it is possible to heat the aluminum die casting product at a temperature higher than or equal to 150° C. and lower than 250° C., and the diameter of the largest particle of the Al—Cu metallic compound that exists in a crystal grain boundary between Si and Al can be made smaller than or equal to 10 μm.

Here, it is preferable to set the frequency of the alternating electric field in a range from 50 Hz to 20 KHz, and to set the electric power of the alternating electric field in a range higher than or equal to 150 W and lower than 250 W. If the frequency of the alternating electric field is set in the range specified above, it is possible to heat the aluminum die casting product in a temperature higher than or equal to 150° C. and lower than 250° C., and as stated above the diameter of the largest particle of the Al—Cu metallic compound that exists in a crystal grain boundary between Si and Al can be made smaller than or equal to 10 μm.

In contrast, if the frequency of the alternating electric field is lower than 50 Hz or if the electric power of the alternating electric field is lower than 150 W, the heating temperature may become lower than 150° C. due to the frequency or electric power being too low and Cu may not be separated. In addition, if the frequency of the alternating electric field is higher than 20 KHz or if the electric power of the alternating electric field is higher than 250 W, the heating temperature may become higher than 250° C. due to the frequency or electric power being too high and Cu may be dispersed.

Applying the alternating electric field having the appropriate frequency and electric power for 10 to 100 minutes ensures the suitable separation of Cu in the structure.

It is preferable that the alternating electric field should have energy density of the aluminum die casting product higher than or equal to 70 W/g. By making the alternating electric field energy be greater than or equal to 70 W/g, the aluminum die casting product can be heated to a temperature higher than or equal to 150° C.

In contrast, if the alternating electric field energy is lower than 70 W/g, the heating temperature of the aluminum die casting product becomes lower than 150° C. because the alternating electric field energy is too low, and as a result Cu cannot be separated. Meanwhile, it is preferable that the alternating electric field should have energy density of the aluminum die casting product lower than or equal to 200 W/g. If the energy density of the aluminum die casting product exceeds 200 W/g, the heating temperature of the aluminum die casting product becomes higher than or equal to 250° C. and Cu may be dispersed.

Applying the alternating electric field having the appropriate energy for 10 to 100 minutes ensures the suitable separation of Cu in the structure.

It is preferable that the alternating electric field should have power density of aluminum die casting product ranging from 50 W/kg to 1000 W/kg. By making the alternating electric field power be in this range, the aluminum die casting product can be heated to a temperature higher than or equal to 150° C. and lower than 250° C. On the other hand, if the alternating electric field power is lower than 50 W/kg, the power is too low and the heating temperature of the aluminum die casting product becomes lower than 150° C., and as a result Cu cannot be separated. In addition, if the alternating electric field power exceeds 1000 W/kg, which is too high, the heating temperature of the aluminum die casting product becomes higher than or equal to 250° C. and Cu may be dispersed.

Applying the alternating electric field having the appropriate power for 10 to 100 minutes ensures the suitable separation of Cu in the structure.

In addition, it is preferable that the frequency of the high-frequency electromagnetic waves should be in a range from 10 MHz to 10 GHz, and the power thereof be higher than or equal to 100 W. If the condition of the frequency and power of the high-frequency electromagnetic waves is met, it is possible to heat the aluminum die casting product at a temperature higher than or equal to 150° C. and lower than 250° C.

In contrast, if the frequency of the high-frequency electromagnetic waves is lower than 10 MHz or the power thereof is lower than 100 W, the heating temperature of the aluminum die casting product becomes lower than 150° C. because the frequency of the high-frequency electromagnetic waves is too low, and as a result Cu cannot be separated. In addition, if the frequency of the high-frequency electromagnetic waves exceeds 10 GHz, which is too high, the heating temperature of the aluminum die casting product becomes higher than or equal to 250° C. and Cu may be dispersed. Meanwhile, it is preferable that the high-frequency electromagnetic waves should have power density of the aluminum die casting product lower than or equal to 200 W/g.

Applying the alternating electric field having the appropriate frequency of the high-frequency electromagnetic waves for 10 to 100 minutes ensures the suitable separation of Cu in the structure.

It is preferable that the high-frequency electromagnetic waves should have energy density higher than or equal to 50 W/g. By making the high-frequency electromagnetic waves energy be higher than or equal to 50 W/g, it is possible to heat the aluminum die casting product in a temperature higher than or equal to 150° C. and lower than 250° C.

In contrast, if the high-frequency electromagnetic waves energy is lower than 50 W/g, which is too low, the heating temperature of the aluminum die casting product becomes lower than 150° C. and Cu cannot be separated. Meanwhile, it is preferable that the high-frequency electromagnetic waves should have energy density of the aluminum die casting product lower than or equal to 200 W/g. If the energy density of the aluminum die casting product exceeds 200 W/g, the heating temperature of the aluminum die casting product becomes higher than or equal to 250° C. and Cu may be dispersed.

According to the present invention, as stated above, an Al—Cu metallic compound does not exist in a crystal grain boundary between Si and Al in both cases when the heating temperature of the aluminum die casting product is lower than 150° C. and Cu is not separated, and when the heating temperature of the aluminum die casting product is higher than 250° C. and Cu is dispersed.

In the reforming method of an aluminum die casting product according to the present invention, it is preferable to heat the aluminum die casting product in alcohol vapor. If the aluminum die casting product is heated in alcohol vapor, it is expected that an alkoxide should be formed on the surface of the aluminum die casting product, which leads to the improvement of corrosion resistance.

The alcohol vapor is preferably, but not necessarily, generated by heating in a temperature ranging from 70 to 110° C. by a heater for heating alcohol and the like.

It is preferable that the alcohol vapor stated above should be provided by heating at least one of ethyl alcohol and methyl alcohol. Ethyl alcohol and methyl alcohol are comparatively less expensive, and also it is easy to obtain alcohol vapor because of its low boiling point, and therefore it is possible to form an alkoxide on the surface of the aluminum die casting product without fail.

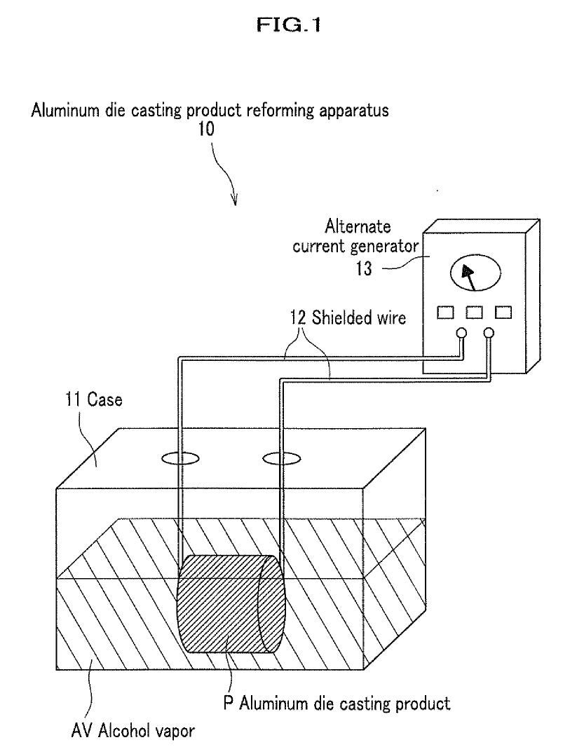

In the reforming method of aluminum die casting product according to the present invention may be exemplarily embodied by, for example, an aluminum die casting product reforming apparatus 10 shown in FIG. 1. The apparatus 10 includes following components therein: a case 11 that contains an aluminum die casting product P and alcohol vapor AV as necessary; a shielded wire 12 that applies an alternating electric field to the aluminum die casting product by contacting thereto and is lead from outside the case 11; an alternate current generator 13 that generates an alternating electric field and is connected to the shielded wire 12. Meanwhile, by using an aluminum die casting product reforming apparatus (not shown) including an electromagnetic wave generator (not shown) for generating high-frequency electromagnetic waves instead of the alternate current generator 13, it is possible to apply high-frequency electromagnetic waves appropriately to the aluminum die casting product P.

when reforming an aluminum die casting product using the apparatus 10, the aluminum die casting product is put in the case 11 of the apparatus 10, and the apparatus is tightly closed so that the aluminum die casting product is connected to the shielded wire 12. In a case when alcohol vapor is to be used in the case 11, set up a small case (not shown) with a heater that is capable of heating ranging from 70 to 110° C. in the case 11, and pour over at least one of the ethyl alcohol and methyl alcohol into the small case so that it is to be heated by the heater.

Next, an alternating electric field is generated by the alternate current generator 13 and applied on the aluminum die casting product via the shielded wire 12. The alternating electric field may have a power, for example, ranging from 150 W to 250 W. If such an alternating electric field is applied, the aluminum die casting product P may be heated to, for example, higher than or equal to 150° C. and lower than 250° C. Once the aluminum die casting product P is heated, Cu is separated in the structure on the surface and inside thereof and structure becomes uneven. Then, the largest particle of Al—Cu metallic compound that exists in a crystal grain boundary between Si and Al will be formed with a diameter smaller than or equal to 10 μm. As a result, the corrosion resistance will be improved.

### Examples

Next, examples of the aluminum die casting product according to the present invention and reforming method thereof will be explained.

### (1) Investigation of Reforming by Applying an Alternating Electric Field

First, reforming by applying alternating electric field was investigated. In this investigation, the relation between a pitting potential and a corrosion resistance of the aluminum die casting product was examined by reproducing pitting corrosion by anode polarization on the aluminum die casting product with applying an alternating electric field thereto.

First, a cylindrical aluminum die casting product using an aluminum die casting alloy ADC12 (the content of Cu thereof is 2.3 mass percent) was produced based on the die-casting method. Here, the conditions of the die-casting method are: a mold temperature 230° C., dissolution 700° C. a casting temperature 670° C., and a pressure 90 MPa.

The aluminum die casting product was stored in the case in the aluminum die casting product reforming apparatus shown in FIG. 1, and was reformed by applying an alternating electric field of 200 Hz and 200 W thereto for 60 minutes (practical example 1). This alternating electric field was so controlled that the energy density of the aluminum die casting product is 70 to 100 W/g, and the power density of the aluminum die casting product is about 700 W/kg.

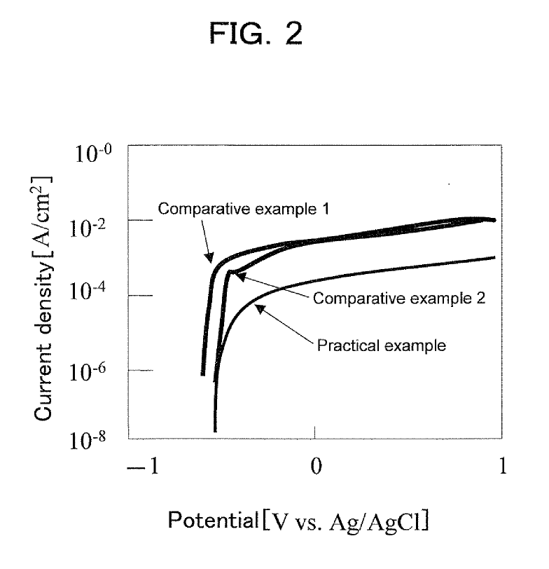

Then an anode polarization measurement was performed on the reformed aluminum die casting product of the practical example 1 and the non-reformed aluminum die casting product of a comparative example 1. The anode polarization measurement was performed by measuring a current flowing between the cathode and the anode in saline solution of 3.5% at 25° C. at a 20 mV step while scanning the anode electrode potential by 20 mV/min from the corrosion potential for the reformed aluminum die casting product to become anodically polarized. The result of the anode polarization measurement is shown in FIG. 2.

As shown in FIG. 2, the current density [A/cm²] of the aluminum die casting product according to the practical example 1 which is applied the alternating electric field with the above mentioned condition for 60 minutes is less than 1/10 of that of the aluminum die casting product according to the comparative example 1 which is not applied the above-mentioned reforming and was examined at the potential of 0.92V with reference to the Ag/AgCl reference electrode]. Of course, pitting corrosion was not observed on the surface of the reformed aluminum die casting product according to the practical example 1 (not shown in the figure).

In addition, it was found that when an alternating electric field of 200 Hz, 250° C. was applied to the aluminum die casting product of the practical example 1 and heated the product again at 250° C. (comparative example 2), the comparative example 2 showed the current density which is comparable to the comparative example 1, and the corrosion resistance was reduced compared to the practical example 1.

From the result of (1), it was found that the heat treatment at a temperature higher than or equal to 200° C. and lower than 250° C. by applying the alternating electric field in advance is effective for corrosion control of the aluminum die casting product that is produced using aluminum die casting alloy ADC12.

### (2) Investigation of Reforming by Applying a High-Frequency Electromagnetic Waves

Next, Reforming by applying high-frequency electromagnetic waves was investigated. In this investigation, the relation between a pitting potential and a corrosion resistance of the aluminum die casting product was examined by reproducing pitting corrosion by anode polarization on the aluminum die casting product with applying high-frequency electromagnetic waves thereon.

An aluminum die casting product was produced again in the same condition stated in (1). Then, the aluminum die casting product was stored in the case of the aluminum die casting product reforming apparatus (not shown), and was reformed by heating at 200° C. applying an electromagnetic waves of 2.45 GHz, 100 W for 30 minutes (practical example 2), and for 60 minutes (practical example 3). The electromagnetic waves was so controlled to have an energy density of the aluminum die casting product ranging from 50 to 100 W/g.

Then anode polarization measurement was performed on the aluminum die casting products which were reformed according to the practical examples 2 and 3. The anode polarization measurement was performed in the same condition stated in (1) by measuring a current flowing between the cathode and the anode in saline solution of 3.5% at 25° C. at a 20 mV step while scanning the anode electrode potential by 20 mV/min from the corrosion potential for the reformed aluminum die casting product to become anodically polarized. The results of the above mentioned measurement the practical example 2 and 3 indicate are almost as same as that of the practical example 1 of FIG. 2 (not shown). That is, similarly to practical example 1, the current density [A/cm²] of the aluminum die casting product of the practical example 2 and 3 is smaller than 1/10 of that of the aluminum die casting product of the comparative example 1 which was observed at the anode electrode potential of 0.92V [with reference to the Ag/AgCl reference electrode]. It turned out that pitting corrosion was not observed on the surface of the reformed aluminum die casting product according to the practical example 2 and 3 (not shown in the figure).

In addition, similarly to practical example 1, when the aluminum die casting products of the practical example 2 and 3 were heated again at 250° C., the current density became comparable to the comparative example 1 and the corrosion resistance was reduced compared to the practical examples 2 and 3.

From the result of (1), it was found that the heat treatment in a temperature higher than or equal to 200° C. and lower than 250° C. by applying the high-frequency electromagnetic waves in advance is effective for corrosion control of the aluminum die casting product that is produced using aluminum die casting alloy ADC12.

### (3) Elemental Analysis by Transmission Electron Microscope (TEM) and Energy Dispersive X-ray Analysis

Next, the separation of Cu was examined on the aluminum die casting product according to the practical examples reformed by applying the alternating electric field.

An aluminum die casting product was produced again in the same condition stated in (1). Then, the aluminum die casting product was stored in the case of the aluminum die casting product reforming apparatus shown in FIG. 1, and was reformed by heating at 150° C. or 200° C. by applying an alternating electric field of 200 Hz, 150 W or an alternating electric field of 200 Hz, 200 W for 30 minutes (practical example 4 and 5 respectively). The alternating electric field was controlled in the same condition as that of (1). Here, a comparative example 3 is a case before the alternating electric field was applied to the aluminum die casting product, i.e. before the heat treatment was applied.

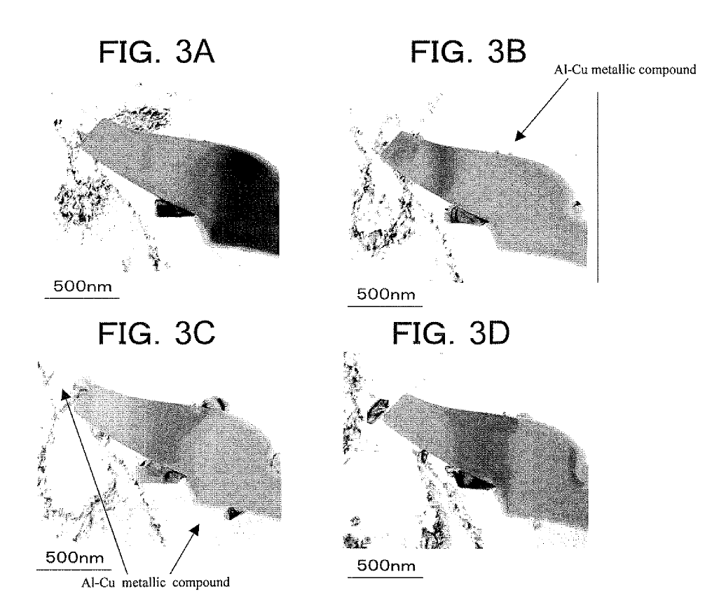

By investigating the aluminum die casting product according to the comparative example 3 and the reformed aluminum die casting products according to the practical example 4 and 5 with a TEM and energy dispersive X-ray analysis, it was found that Cu was dispersed in the comparative example 3 as shown in FIG. 3A. In contrast, in the practical example 4 which was reformed at 150° C., an Al—Cu metallic compound that exists in a crystal grain boundary was locally distributed due to the separation as shown in FIG. 3B. Also in the practical example 5 which was reformed at 200° C., an Al—Cu metallic compound that exists in a crystal grain boundary was distributed due to the separation as shown in FIG. 3C. However, when the aluminum die casting product was heated to 250° C. in the alternating electric field of 200 Hz and 250 W for 30 minutes, Cu was separated again as shown in FIG. 3D (comparative example 4). Here, a scale bar in FIGS. 3A to 3D represents 500 nm.

From the result of (3), with respect to the Cu distribution in the aluminum die casting product made of aluminum die casting alloy ADC12, it was found that it is effective for obtaining the uneven separation of Cu to apply the alternating electric field and to heat at a temperature lower than 250° C.

### (4) Distribution of an Al—Cu Metallic Compound Particles, the Most Frequently Observed Superficial Area, and the Largest Diameter of the Al—Cu Metallic Compound Particle

Next, examinations were performed on the distribution of Al—Cu metallic compound particles, the most frequently observed superficial area, and the largest diameter of the Al—Cu metallic compound particle with a TEM and an elemental analysis by energy dispersive X-ray analysis.

An aluminum die casting product was produced again in the same condition stated in (1). Then, the aluminum die casting product was stored in the case of the aluminum die casting product reforming apparatus shown in FIG. 1, and was reformed by heating at 150° C. and 200° C. by applying an alternating electric field of 200 Hz, 150 W and an alternating electric field of 200 Hz, 250 W (practical example 6 and 7 respectively), and 250′C (comparative example 6). The alternating electric field was controlled with the same condition to that of (1). Here, a comparative example 5 is a case before the alternating electric field was applied to the aluminum die casting product, i.e. before the heat treatment was applied.

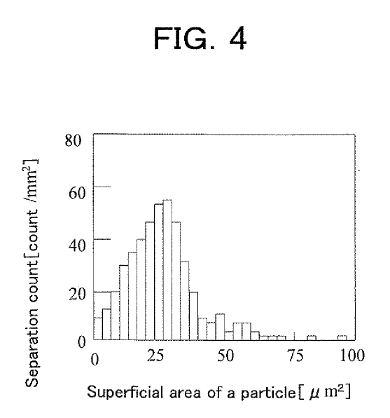

Then examinations were made on the aluminum die casting product of the comparative example 5 and the reformed aluminum die casting products of the practical example 6 and 7, and the aluminum die casting product of the comparative example 6 with a. TEM and energy dispersive X-ray analysis. FIG. 4 shows a relation between superficial area of a particle [μm²] and separation count [count/mm²] in a practical example 6 investigated with a TEM.

As shown in the histogram of FIG. 4, the most frequently observed superficial area of the Al—Cu metallic compound in the aluminum die casting product according to the practical example 6 was 30 μm². In addition, the distribution was concentrated in a particle area of 30±10 μm².

Further, the content of the Al—Cu metallic compound per unit area (mm²) was calculated, that is the Cu content per unit area (mm²), from the superficial area of a particle and separation count shown in the histogram in FIG. 4, and then the Cu content per unit volume (mm³) was calculated assuming that Cu is distributed similarly in a thickness direction. The calculation result of the Cu content per unit volume (mm³) was 2.3 mass percent ±25 percent.

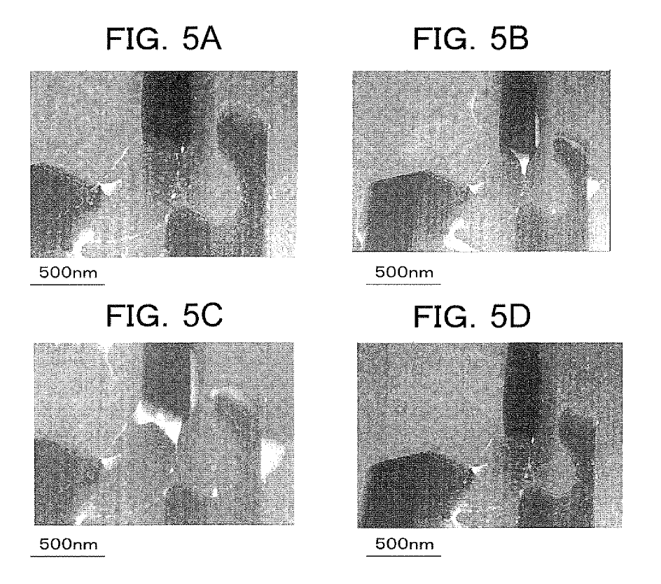

In addition, photographs of a comparative example 5, practical example 6 and 7, and comparative example 6 taken with a TEM are shown in FIGS. 5A to 5D respectively. Here, a scale bar in FIGS. 5A to 5D shows 500 nm. From FIGS. 5A to 5D, it was found that the largest diameter of the metallic compound particle in the practical example 6 and 7 is smaller than or equal to 10 μm.

Further, from the TEM photographs shown in FIGS. 5A to 5D, as shown in the Table 1 below, the mean grain volume of the Al—Si metallic compound that exists in a crystal grain boundary of Si and Al was unmeasurable in the comparative example 5 which was not heated and in the comparative example 6 which was heated at 250° C. (shown as “−” in Table 1). In contrast, the mean grain volume in the practical example 6 heated at 150° C. was 15 μm, and the mean grain volume in the practical example 7 heated at 200° C. was 20 μm respectively. That is, the mode value of the grain volume of an Al—Cu metallic compound that exists in a crystal grain boundary of Si and Al is smaller than or equal to 30 μm³.

TABLE 1

| | mean grain volume |
|---|---|
| | [μm³] |
| comparative example 5 | — |
| practical example 6 | 15 |
| practical example 7 | 20 |
| comparative example 6 | — |

From the result of (4), it was found to be effective to apply an alternating electric field for the fine separation of Al—Cu metallic compound particles with respect to the distribution of the Al—Cu metallic compound particle of the aluminum die casting product produced by using aluminum die casting alloy ADC12, the most frequently observed superficial area, and to the largest diameter of Al—Cu metallic compound particles.

### (5) Investigation of Reforming by Heat Treatment Using a Heater

Next, it was investigated whether or not the reforming equivalent to the cases where applying an alternating electric field or high-frequency electromagnetic waves can be performed by heat treatment using a heater.

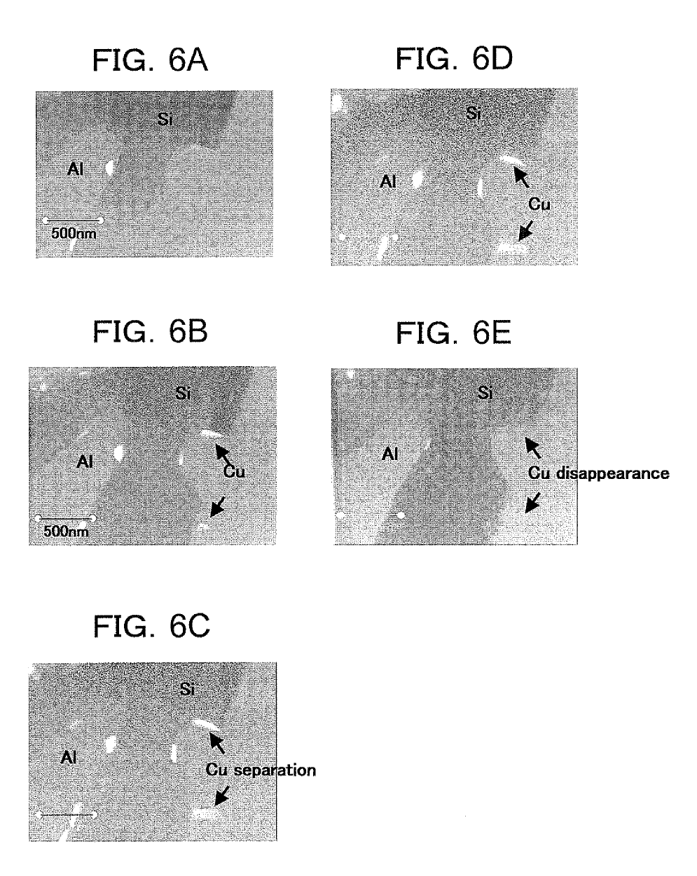

An aluminum die casting product was produced again in the same condition stated in (1). Then heat treatments in several conditions were performed to the produced aluminum die casting product. The conditions are: a case where no heat treatment with a heater is applied (comparative example 7), a case where heat treatment with a heater is applied and reached 200° C. (practical example 8), a case where heated with a heater at a temperature of 200° C. for 30 minutes (practical example 9), a case where heated at a temperature of 200° C. and further reached 250° C. (comparative example 8) and 30 minutes passed after reaching 250° C. (comparative example 9), and TEM photographs of which are shown in FIGS. 6A to 6E. Here, a scale bar in FIGS. 6A to 6E represents 500 nm.

Since the aluminum die casting product of comparative example 7 shown in FIG. 6A was not applied heat treatment, Cu was distributed and no separation of Cu was observed. In contrast, since the aluminum die casting product of practical example 8 shown in FIG. 6B and the aluminum die casting product of practical example 9 shown in FIG. 6C were both heated at 200° C., separation of Cu in a crystal grain boundary between Si and Al was observed in the same way to TEM photographs of practical example 4, 5, 6, and 7 (see FIGS. 3B, 3C, 5B and 5C). In addition, in the aluminum die casting product of practical example 9 shown in FIG. 6C, the separation amount was large because it was heated at 200° C. for 60 minutes. On the other hand, in the aluminum die casting product of the practical example 8 shown in FIG. 6D, since it was further heated and reached 250° C., Cu was dispersed and the separation amount was slightly reduced compared to the TEM photograph of FIG. 6C. In addition, in the aluminum die casting product of the comparative example 9 shown in FIG. 6E, since the heat treatment was continued at 250° C. for further 30 minutes, the Cu separated on the crystal grain boundary between Si and Ai was almost dispersed and disappeared, and therefore no separation of Cu was observed.

### (6) Investigation of Reforming by Heat Treatment in Alcohol Vapor

Next, reforming by heat treatment in alcohol vapor was investigated. In this investigation, we inspected the relation between a pitting potential and a corrosion resistance of the aluminum die casting product by reproducing pitting corrosion reproduced by anode polarization on the aluminum die casting product heated in alcohol vapor.

An aluminum die casting product was produced again in the same condition stated in (1). Then, the aluminum die casting product was stored in the case in the aluminum die casting product reforming apparatus shown in FIG. 1, and was reformed by heating at 200° C. by applying an alternating electric field of 200 Hz, 200 W for 60 minutes (practical example 10). In this investigation, ethyl alcohol was used and the alternating electric field was controlled in the same condition as that of (1).

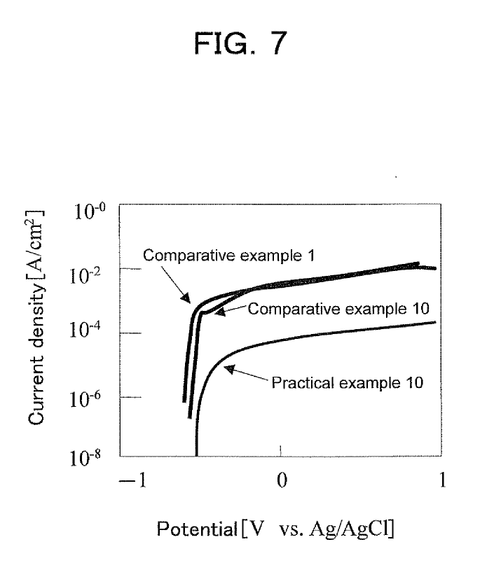

Then an anode polarization measurement was performed in the same way as previously stated using the reformed aluminum die casting product of the practical example 10 reformed by heating in alcohol vapor. The anode polarization measurement was performed by measuring a current flowing between the cathode and the anode in saline solution of 3.5% at 25° C. at a 20 mV step while scanning the anode electrode potential by 20 mV/min from the corrosion potential for the reformed aluminum die casting product to become anodically polarized. The result of the anode polarization measurement is shown in FIG. 7.

As shown in FIG. 7, the current density [A/cm²] of the aluminum die casting product according to the practical example 10 is less than 1/100 of that of the aluminum die casting product according to the comparative example 1 which was observed under the condition of 0.92V [with reference to the Ag/AgCl reference electrode]. In addition, when the aluminum die casting product of practical example 10 was further heated at 250° C. for 60 minutes, it showed the current density with a comparable level to the comparative example 1 as shown in FIG. 7 (comparative example 10).

In addition, the corrosion rate was compared among the comparative example 1, the practical example 1, and the practical example 10. In the comparison of the corrosion rate, first the current density of the comparative example 1 was normalized as 1, and then the corrosion rate of the practical example 1 and the practical example 10 was evaluated. The result is shown in Table 2 below.

TABLE 2

| | Corrosion rate |
|---|---|
| | (normalizing the comparative |
| | example 1 as 1) |
| comparative example 1 | 1 |
| practical example 1 | 0.09 |
| practical example 10 | 0.075 |

As shown on Table 2, the corrosion rate of the practical example 1 is 0.09 and the corrosion resistance was considerably improved. In addition, the corrosion rate of the practical example 10 heated in the alcohol vapor was 0.075, which is better than practical example 1 with respect to the corrosion resistance.

### (7) Mechanical Property

Next, the mechanical property of the reformed aluminum die casting product was investigated.

An aluminum die casting product was produced again in the same condition stated in (1). Then, the aluminum die casting product was stored in the case of the aluminum die casting product reforming apparatus shown in FIG. 1, and was reformed by heating at 200° C. applying an alternating electric field of 200 Hz, 200 W for 30 minutes (practical example 11). The alternating electric field was controlled in the same condition as that of (1).

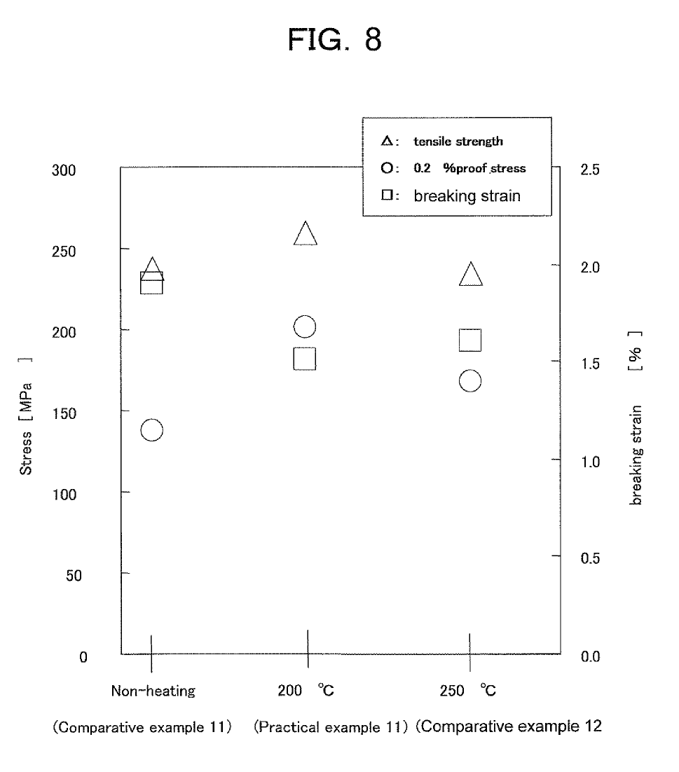

Then, the mechanical property was measured about the aluminum die casting product according to the practical example 11 via a small sample tensile testing machine observing a stress and strain curve until the test sample breaks. The result is shown in FIG. 8 including a case where the reproduced aluminum die casting product is not reformed (comparative example 11), and a case where the aluminum die casting product is heated in 250° C. applying an alternating electric field of 200 Hz, 250 W for 60 minutes (comparative example 12).

As shown in FIG. 8, in the practical example 11 which performed the reforming by heating at 200° C. applying the alternating electric field, the strength represented by 0.2% proof stress and pull strength was increased compared to the comparative example 11, but on the other hand the breaking strain was reduced. In the comparative example 12, these properties were declined due to the re-heating at 250 t, and the strength represented by 0.2% proof stress and pull strength was decreased more than 10%.

What is claimed is:

1. An aluminum die casting product containing Si and Cu, comprising particles of an Al—Cu metallic compound that exist at a crystal grain boundary between a Si crystal grain and an Al crystal grain, the largest particle of the Al—Cu compound having a diameter smaller than or equal to 10 μm.

2. The aluminum die casting product according to claim 1, wherein the particles of the Al—Cu metallic compound have a mode value of grain volume smaller than or equal to 30 μm³.

3. The aluminum die casting product according to claim 1, wherein an average Cu content of the entire aluminum die casting product is in a range from 1 to 20 mass percent, and a Cu content of a divided volume of 1 mm³ of the aluminum die casting product is in a range of ±25 percent of the average Cu content of the entire aluminum die casting product.

4. A reforming method of an aluminum die casting product containing Si and Cu, comprising a heating step of the aluminum die casting product being heated at a temperature higher than or equal to 150° C. and lower than 250° C.

5. The reforming method of an aluminum die casting product according to claim 4, wherein the heating step is performed by heating the aluminum die casting product by one of applying an alternating electric field, applying high-frequency electromagnetic waves, and a heater.

6. The reforming method of an aluminum die casting product according to claim 5, wherein the alternating electric field has a frequency ranging from 50 Hz to 20 kHz.

7. The reforming method of an aluminum die casting product according to claim 5, wherein the applied alternating electric field has an energy density of the aluminum die casting product larger than or equal to 70 W/g.

8. The reforming method of an aluminum die casting product according to claim 5, wherein the applied alternating electric field has a power density of the aluminum die casting product ranging from 50 W/kg to 1000 W/kg.

9. The reforming method of an aluminum die casting product according to claim 5, wherein the applied alternating electric field has a frequency ranging from 10 MHz to 10 GHz, and has power larger than or equal to 100 W.

10. The reforming method of an aluminum die casting product according to claim 5, wherein the applied alternating electric field has energy density of the aluminum die casting product larger than or equal to 50 W/g.

11. The reforming method of an aluminum die casting product according to claim 5, wherein the aluminum die casting product is heated in alcohol vapor.

12. The reforming method of an aluminum die casting product according to claim 11, wherein the alcohol vapor is heated at a temperature ranging from 70 to 110° C.

13. The reforming method of an aluminum die casting product according to claim 11, wherein the alcohol vapor is provided by heating at least one of ethyl alcohol and methyl alcohol.
